(19) United States
(12) Patent Application Publication
(10) Pub. No.: US 2026/0148995 A1
(43) Pub. Date: May 28, 2026

(54) ELECTRODES FOR RECHARGEABLE LITHIUM BATTERIES, METHOD FOR MANUFACTURING THE SAME, AND RECHARGEABLE LITHIUM BATTERIES INCLUDING THE SAME

(71) Applicant: SAMSUNG SDI CO., LTD., Yongin-si (KR)

(72) Inventor: Sungeun WANG, Yongin-si (KR)

(73) Assignee: SAMSUNG SDI CO., LTD., Yongin-si (KR)

(21) Appl. No.: 19/396,479

(22) Filed: Nov. 21, 2025

(30) Foreign Application Priority Data
Nov. 28, 2024 (KR) 10-2024-0174127

(51) Int. Cl. H01M 4/62; H01M 4/04; H01M 4/131; H01M 10/052

(52) U.S. Cl. CPC H01M 4/628; H01M 4/043; H01M 4/131; H01M 4/623; H01M 4/625; H01M 10/052

(57) ABSTRACT

Provided are an electrode for a rechargeable lithium battery, a method for manufacturing an electrode for a rechargeable lithium battery, and a rechargeable lithium battery, the electrode including a current collector; and an electrode active material layer disposed on the current collector and including an electrode active material, cellulose nanofibers, and polytetrafluoroethylene.

### CROSS-REFERENCE TO RELATED APPLICATION

This application claims priority to Korean Patent Application No. 10-2024-0174127 filed at the Korean Intellectual Property Office on Nov. 28, 2024, the entire contents of which are incorporated herein by reference.

### BACKGROUND

### 1. Field

Electrodes for a rechargeable lithium battery, methods for manufacturing the electrodes, and rechargeable lithium batteries including the electrodes are disclosed.

### 2. Description of the Related Art

With increasing presence of electronic devices that use batteries, such as, e.g., mobile phones, laptop computers, electric vehicles, and the like, the demand for rechargeable batteries with high energy density and high capacity is increasing. Accordingly, improving the performance of rechargeable lithium batteries may be advantageous.

Rechargeable lithium batteries include electrodes (positive electrode and negative electrode) including an active material capable of intercalating and deintercalating lithium ions, and an electrolyte, and generate electrical energy through oxidation and reduction reactions when lithium ions are intercalated and deintercalated between the positive electrode and the negative electrode.

Typically, the electrodes are manufactured through a wet process, which includes a drying process to remove the solvent. During the drying process, the composition within the electrode may become uneven as the solvent evaporated, making it challenging to manufacture a thick-film electrode.

There is a process for manufacturing electrodes through a dry process that does not use solvents to solve these shortcomings. Electrodes manufactured using such dry process may be economical in that the electrodes can be readily thickened, and the costs required for the solvent recycling process and solvent drying process may be reduced.

### SUMMARY

Some example embodiments include an electrode for a rechargeable lithium battery having improved impregnation properties of an electrolyte solution and adhesive strength, and having a thick film.

Some example embodiments include a rechargeable lithium battery having increased capacity, improved charge/discharge efficiency, high-rate characteristics, and cycle-life characteristics, including the electrode.

An electrode for a rechargeable lithium battery according to some example embodiments includes a current collector, and an electrode active material layer disposed on the current collector and including an electrode active material, cellulose nanofibers, and polytetrafluoroethylene.

According to some example embodiments, a method for manufacturing an electrode for a rechargeable lithium battery includes freeze-drying cellulose nanofiber suspension to prepare cellulose nanofibers, dry mixing the prepared cellulose nanofiber and polytetrafluoroethylene to prepare a mixed binder, dry mixing the mixed binder, an electrode active material, and a conductive material to prepare an electrode mixture, and forming the electrode mixture into a sheet to prepare a film, and laminating the film on a current collector to manufacture an electrode.

A rechargeable lithium battery according to some example embodiments includes the electrode and an electrolyte.

An electrode for a rechargeable lithium battery according to some example embodiments improves impregnation properties of an electrolyte solution and adhesive strength, and facilitates thickening, and a rechargeable lithium battery including the electrode exhibits increased capacity, improved charge/discharge efficiency, high-rate characteristics, and cycle-life characteristics.

### BRIEF DESCRIPTION OF THE DRAWINGS

FIG. 1 to FIG. 4 are views schematically showing rechargeable lithium batteries according to some example embodiments.

FIG. 5 is a flowchart illustrating a method of manufacturing an electrode for a rechargeable lithium battery, according to some example embodiments.

### DETAILED DESCRIPTION

Hereinafter, example embodiments are described in detail. However, these embodiments are presented as examples, and the present disclosure is not limited thereto, and the present disclosure is defined by the scope of the claims described below.

As used herein, when a specific definition is not otherwise provided, it is understood that when an element such as a layer, film, region, or substrate is referred to as being “on” another element, the element can be directly on the other element, or intervening elements may also be present therebetween.

Unless otherwise specified in this specification, what is indicated in the singular may also include the plural. In addition, unless otherwise specified, “A or B” may mean “including A, including B, or including A and B.”

As used herein, “combination thereof” indicates a mixture, a laminate, a composite, a copolymer, an alloy, a blend, a reaction product, and the like of the constituents.

As used herein, when a definition is not otherwise provided, the particle diameter may be an average particle diameter. In addition, the particle diameter may refer to an average particle diameter (D₅₀), which means the diameter of particles having a cumulative volume of 50 volume % in the particle size distribution. The average particle diameter (D₅₀) may be measured by a method known to those skilled in the art, for example, by a particle size analyzer, or by a transmission electron microscope image, or a scanning electron microscope image. Alternatively, a dynamic light-scattering measurement device is used to perform a data analysis, and the number of particles is counted for each particle size range. From this, the average particle diameter (D₅₀) value may be readily obtained through a calculation. Alternatively, the average particle diameter (D₅₀) value can be measured using a laser diffraction method. When measuring by the laser diffraction method, for example, the particles to be measured are dispersed in a dispersion medium, and then introduced into a commercially available laser diffraction particle diameter measuring device (e.g., Microtrac MT 3000), and ultrasonic waves of about 28 kHz with an output of 60 W are irradiated to calculate an average particle diameter (D₅₀) on the basis of 50% of the particle diameter distribution in the measuring device.

When the terms “about” or “substantially” are used in this specification in connection with a numerical value, it is intended that the associated numerical value include a tolerance of +10% around the stated numerical value. When ranges are specified, the range includes all values therebetween such as increments of 0.1%.

### Electrode for Rechargeable Lithium Battery

An electrode for a rechargeable lithium battery according to some example embodiments includes a current collector and an electrode active material layer on the current collector. The electrode active material layer includes an electrode active material, cellulose nanofibers (CNF), and polytetrafluoroethylene (PTFE). The electrode active material layer may be disposed on one surface, or on both surfaces, of the current collector.

Dry binders used in the existing dry electrode manufacturing process are mainly hydrophobic, and thus impregnation properties of an electrolyte solution are poor, making it challenging to thicken the electrode, and the electrochemical performance of the battery may be deteriorated.

An electrode according to some example embodiments has an advantage in that the impregnation properties of an electrolyte solution are improved, and the electrode may be readily formed into a thick film by including a mixed binder in which cellulose nanofibers having amphiphilic properties are mixed with polytetrafluoroethylene that is a dry binder.

The cellulose nanofibers (CNF) may act as a binder. Because the cellulose nanofibers have amphiphilic properties, the cellulose nanofibers can be used together with polytetrafluoroethylene, which has hydrophobic properties, to improve the impregnation properties of an electrolyte solution of the dry electrode. In addition, when cellulose nanofibers are used alone, dispersibility may be insufficient, but when used together with polytetrafluoroethylene, which has hydrophobicity, cellulose nanofibers can be substantially uniformly dispersed within the electrode mixture during the manufacture of a dry electrode. In addition, because the cellulose nanofibers have desired or improved mechanical strength and flexibility, the durability of a dry electrode including cellulose nanofibers may be improved.

For example, an average diameter of the cellulose nanofibers may be in a range of about 0.1 nm to about 200 nm, for example, about 1 nm to about 100 nm, about 3 nm to about 50 nm, or about 5 nm to about 20 nm.

The diameter of the cellulose nanofibers may refer to the widest diameter among the diameters of the fibers measured based on the cross-section of each nanofiber, and may be measured in a direction perpendicular to the longitudinal direction of the nanofibers.

The average diameter of the cellulose nanofibers may be calculated by randomly measuring the cross-sectional diameters of about 20 fibers in a scanning electron microscope image of the surface of the electrode active material layer, and calculating the arithmetic average thereof.

When the numerical range is satisfied, a dry electrode with desired or improved durability may be manufactured because the dispersibility within the electrode mixture is improved.

For example, an average length of the cellulose nanofibers may be in a range of about 1 μm to about 20 μm, for example about 5 μm to about 20 μm, about 5 μm to about 15 μm, about 5 μm to about 10 μm, or about 10 μm to about 15 μm.

The average length of the cellulose nanofibers may be calculated by randomly measuring the lengths of about 20 fibers in a scanning electron microscope image of the surface of the electrode active material layer, and calculating the arithmetic mean thereof.

When the above ranges for the average diameter and the average length are satisfied, a bonding force between the electrode active material, conductive material, and current collector is substantially desired or improved during the manufacture of the dry electrode, so that a dry electrode with desired or improved durability may be manufactured.

For example, the cellulose nanofibers may be included in an amount in a range of about 0.01 wt % to about 5 wt %, for example, about 0.01 wt % to about 2.5 wt %, about 0.01 wt % to about 1 wt %, or about 0.5 wt % to about 1 wt % based on 100 wt % of the electrode active material layer. When the cellulose nanofibers are included in an amount that is less than about 0.01 wt % based on 100 wt % of the electrode active material layer, it may be challenging to sufficiently improve the impregnation properties of an electrolyte solution of the dry electrode, and when the cellulose nanofibers are included in an amount that is greater than about 5 wt %, the electrode resistance may increase, resulting in a decrease in battery performance.

For example, the cellulose nanofibers may be prepared by freeze-drying.

The cellulose nanofibers prepared through freeze-drying may be dried into powder form while maintaining the fiber form, so that the cellulose nanofibers may be substantially uniformly fibrillated, thereby improving the mechanical properties of an electrode including the cellulose nanofibers.

The freeze-drying process is described in detail in the manufacturing method below.

The polytetrafluoroethylene (PTFE) may be or include a dry binder that is not impregnated, dissolved or dispersed in a process solvent during the dry electrode manufacturing process, and may be or include a binder that includes a process solvent or does not come into contact with a process solvent during the dry electrode manufacturing process.

For example, in the process of manufacturing an electrode film by sheeting an electrode mixture, a portion or all of the dry binder in particle form may be fibrillated to form an electrode active material layer including the dry binder.

The polytetrafluoroethylene has desired or improved heat resistance, flexibility, and mechanical strength, and thus is able to manufacture a dry electrode with desired or improved mechanical strength when used as a dry binder.

For example, the polytetrafluoroethylene may be included in an amount in a range of about 0.01 wt % to about 5 wt %, for example, about 0.5 wt % to about 5 wt %, about 0.5 wt % to about 2.5 wt %, about 1 wt % to about 2.5 wt %, or about 1 wt % to about 2 wt % based on 100 wt % of the electrode active material layer.

When the polytetrafluoroethylene is included in an amount that is less than about 0.01 wt % based on 100 wt % of the electrode active material layer, the adhesiveness and durability of the dry electrode may be low, and when the polytetrafluoroethylene is included in an amount that is greater than about 5 wt %, the electrode resistance may increase, resulting in a decrease in battery performance.

For example, a weight ratio of the cellulose nanofibers to the polytetrafluoroethylene may be in a range of about 2:8 to about 8:2, for example, a weight ratio of about 2.5:7.5 to about 8:2, or a weight ratio of about 2.5:7.5 to about 5:5. When the above cellulose nanofibers and the polytetrafluoroethylene are included in the electrode active material layer at the above weight ratio, the mechanical strength is desired or improved and the impregnation properties of an electrolyte solution are improved, so that the cellulose nanofibers can be readily used in a thick-film electrode.

The electrode active material layer may further include other dry binders.

The other dry binders may include at least one of polyvinylidene a fluoride-hexapropylene (PVDF-HFP) copolymer, a polyvinylidene fluoride-hexafluoropropylene copolymer, polyethylene oxide, polyvinyl alcohol, polyacrylonitrile, starch, hydroxypropyl cellulose, cellulose, polyvinyl pyrrolidone, polyethylene, polypropylene, an ethylene-propylene-diene polymer (EPDM), sulfonated-EPDM, a styrene butadiene rubber (SBR), a fluoroelastomer, a copolymer thereof, or a combination thereof.

For example, the electrode active material layer may further include a conductive material.

The conductive material may be or include a dry conductive material, and the dry conductive material may be or include, for example, a conductive material that is not impregnated, dissolved or dispersed in a process solvent during the manufacturing process of a dry electrode mixture and a dry electrode film, and may be or include a conductive material that does not include a process solvent or does not come into contact with a process solvent.

For example, the conductive material may include a carbon-based conductive material, and the carbon-based conductive material may include at least one of natural graphite, artificial graphite, carbon black, acetylene black, Ketjen black, a carbon fiber, a carbon nanofiber, a carbon nanotube, and a combination thereof.

For example, the carbon-based conductive material may include at least one of a fibrous carbon-based material having an aspect ratio that is greater than or equal to about 10, a particle-shaped carbon-based material having an aspect ratio that is less than about 10, or a combination thereof.

The conductive material may further include at least one of a metal-based material containing at least one of copper, nickel, aluminum, silver, and the like, in the form of metal powder or metal fiber; a conductive polymer such as a polyphenylene derivative; or a combination thereof.

The conductive material may be included in an amount in a range of about 0.01 wt % to about 5 wt %, for example, about 0.05 wt % to about 5 wt %, or about 0.1 wt % to about 5 wt % based on 100 wt % of the electrode active material layer. When the above numerical range is satisfied, a thick-film electrode with desired or improved lithium ionic conductivity may be formed.

For example, the electrode active material layer may further include an inorganic solid electrolyte.

For example, the inorganic solid electrolyte may include at least one of a sulfide-based solid electrolyte, an oxide-based solid electrolyte, a halide-based solid electrolyte, or a combination thereof, and as an example, the inorganic solid electrolyte may include a sulfide-based solid electrolyte.

Because the electrode is manufactured in a dry manner, the electrode active material layer includes little or no solvent, and therefore does not cause a side reaction with the solvent even when the electrode active material layer further includes an inorganic solid electrolyte.

The sulfide-based solid electrolytes may include, for example, at least one of Li₂S—P₂S₅, Li₂S—P₂S₅—LiX (where X is or includes a halogen element, for example, I or Cl), Li₂S—P₂S₅—Li₂O, Li₂S—P₂S₅—Li₂O—LiI, Li₂S—SiS₂, Li₂S—SiS₂—LiI, Li₂S—SiS₂—LiBr, Li₂S-SiS₂—LiCl, Li₂S—SiS₂—B₂S₃—LiI, Li₂S—SiS₂—P₂S₅—LiI, Li₂S—B₂S₃, Li₂S—P₂S₅—ZₘSₙ (where m and n are integers, respectively, and Z is or includes Ge, Zn, or Ga), Li₂S—GeS₂, Li₂S—SiS₂—Li₃PO₄, Li₂S—SiS₂-LiₚMO_{q} (where p and q are integers, and M is or includes P, Si, Ge, B, Al, Ga or In), or a combination thereof.

For example, the sulfide-based solid electrolyte particles may include argyrodite-type sulfide. The argyrodite-type sulfide may be represented by a chemical formula of, for example, LiₐM_{b}P_{c}S_{d}Aₑ (wherein a, b, c, d, and e are all in a range of about 0 or more and about 12 or less, M is or includes a metal other than Li or a combination of multiple metals other than Li, and A is F, Cl, Br, or I), and as an example, the argyrodite-type sulfide may be represented by a chemical formula of Li₇₋ₓPS₆₋ₓAₓ (wherein x is in a range of about 0.2 or more and about 1.8 or less, and A is F, Cl, Br, or I). The argyrodite-type sulfide may for example be Li₃PS₄, Li₇P₃S₁₁, Li₇PS₆, Li₆PS₅Cl, Li₆PS₅Br, Li_{5.8}PS_{4.8}Cl_{1.2}, Li_{6.2}PS_{5.2}Br_{0.8}, and the like.

The oxide-based inorganic solid electrolytes include, for example, at least one of Li₁₊ₓTi₂₋ₓAl(PO₄)₃(LTAP) (0≤x≤4), Li_{1+x+y}AlₓTi₂₋ₓSi_{y}P_{3-y}O₁₂ (0<x<2, 0≤y≤3), BaTiO₃, Pb(Zr,Ti)O₃(PZT), Pb₁₋ₓLaₓZr_{1-y}Ti_{y}O₃(PLZT) (0≤x<1, 0≤y<1), PB(Mg₃Nb_{2/3})O₃—PbTiO₃(PMN-PT), HfO₂, SrTiO₃, SnO₂, CeO₂, Na₂O, MgO, NiO, CaO, BaO, ZnO, ZrO₂, Y₂O₃, Al₂O₃, TiO₂, SiO₂, lithium phosphate (Li₃PO₄), lithium titanium phosphate (LiₓTi_{y}(PO₄)₃, 0<x<2, 0<y<3), Li_{1+x+y}(Al, Ga)ₓ(Ti, Ge)₂₋ₓSi_{y}P_{3-y}O₁₂ (0≤x≤1, 0≤y≤1), lithium lanthanum titanate (LiₓLa_{y}TiO₃, 0<x<2, 0<y<3), Li₂O, LiAlO₂, Li₂O—Al₂O₃—SiO₂—P₂O₅—TiO₂—GeO₂-based ceramics, garnet-based ceramics Li₃₊ₓLa₃M₂O₁₂ (M=Te, Nb, or Zr; x is an integer in a range from 1 to 10), or a combination thereof.

The halide-based solid electrolyte may include a Li element, an M element (M is or includes a metal other than Li), and an X element (X is or includes a halogen). Examples of X may include F, Cl, Br, and I. In particular, the halide-based solid electrolyte in which X is or includes at least one of Br and Cl may be suitable. In addition, M may be or include, for example, a metal element such as at least one of Sc, Y, B, Al, Ga, and In.

A composition of the halide-based solid electrolyte is not particularly limited, but may be represented by Li₆₋₃ₐMₐBr_{b}Cl_{c} (wherein M is or includes a metal other than Li, 0<a<2, 0≤b≤6, 0≤c≤6, and b+c=6). At this time, “a” may be equal to about 0.75 or greater, 1 or greater, and may be 1.5 or less. The “b” may be equal to about 1 or more, and may be equal to about 2 or more. Additionally, the “c” may be equal to about 3 or more, or equal to about 4 or more. Examples of the halide-based solid electrolyte may include at least one of Li₃YBr₆, Li₃YCl₆, or Li₃YBr₂Cl₄.

For example, the electrode may be manufactured in a dry manufacturing process. Accordingly, the electrode active material layer may further include a solvent including an organic solvent or an aqueous solvent, but the solvent may be included in an amount that is less than about 0.01 wt % based on 100 wt % of the electrode active material layer, and as an example, the solvent may not be included.

Because the electrode active material layer includes almost no solvent, less than about 0.01 wt %, the electrode may be referred to being manufactured by a dry process. The dry manufacturing process of these electrodes is described below.

For example, when the electrode active material layer is a positive electrode active material layer, the organic solvent may be further included, and the organic solvent may be included in an amount that is less than about 0.01 wt % based on 100 wt % of the positive electrode active material layer. Any type of organic solvent used in the manufacture of a positive electrode active material layer slurry may be used without limitation, and may include, for example, N-methyl-2-pyrrolidone (NMP).

For example, when the electrode active material layer is a negative electrode active material layer, the aqueous solvent may be further included, and the aqueous solvent may be included in an amount that is less than about 0.01 wt % based on 100 wt % of the negative electrode active material layer. As for the type of the aqueous solvent, any aqueous solvent used in the manufacture of the negative electrode active material layer slurry may be used without limitation, and may include, for example, water.

The electrode active material layer may be formed into a thick film with a sufficient thickness by including both the aforementioned cellulose nanofibers and polytetrafluoroethylene, so that impregnation properties of an electrolyte solution may be improved. For example, the thickness of the electrode active material layer may be greater than or equal to about 150 μm, for example, greater than or equal to about 200 μm, or greater than or equal to about 250 μm. For example, the thickness of the electrode active material layer may be in a range of about 150 μm to about 500 μm, about 150 μm to about 400 μm, about 200 μm to about 400 μm, or about 200 μm to about 300 μm.

For example, the electrode active material may be included in an amount in a range of about 90 wt % to about 99.5 wt %, for example, about 90 wt % to about 99 wt %, based on 100 wt % of the electrode active material layer.

For example, the electrode active material may include a positive electrode active material, in which case the electrode may be or include a positive electrode.

A positive electrode for a rechargeable lithium battery may include a current collector, and a positive electrode active material layer formed on the current collector. The positive electrode active material layer includes a positive electrode active material and may optionally further include an additive that can constitute a sacrificial positive electrode.

For example, the positive electrode active material may be or include a compound (lithiated intercalation compound) capable of intercalating and deintercallating lithium. For example, at least one composite oxide of lithium and a metal such as or including at least one of cobalt, manganese, nickel, and combinations thereof may be used.

The composite oxide may be or include a lithium transition metal composite oxide, and examples thereof include at least one of a lithium nickel-based oxide, a lithium cobalt-based oxide, a lithium manganese-based oxide, a lithium iron phosphate-based compound, a cobalt-free lithium nickel-manganese oxide, or a combination thereof.

As an example, a compound represented by any one of the following chemical formulas may be used. LiₐA_{1-b}X_{b}O_{2-c}D_{c} (0.90≤a≤1.8, 0≤b≤0.5, 0≤c≤0.05); LiₐMn_{2-b}X₆O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<α<2); LiₐNi_{b}Co_{c}L¹_{d}GeO₂ (0.90≤a≤1.8, 0≤b≤0.9, 0≤c≤0.5, 0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0≤g≤0.5); Li_{(3-f)}Fe₂(PO₄)₃ (0≤f≤2); and LiₐFePO₄ (0.90≤a≤1.8).

In the chemical formulas, A is or includes at least one of Ni, Co, Mn, or a combination thereof; X is or includes at least one of Al, Ni, Co, Mn, Cr, Fe, Mg, Sr, V, a rare earth element, or a combination thereof; D is or includes at least one of O, F, S, P, or a combination thereof; G is or includes at least one of Al, Cr, Mn, Fe, Mg, La, Ce, Sr, V, or a combination thereof; and L¹ is or includes at least one of Mn, Al, or a combination thereof.

For example, the positive electrode active material may be or include a high nickel-based positive electrode active material having a nickel content that is greater than or equal to about 80 mol %, greater than or equal to about 85 mol %, greater than or equal to about 90 mol %, greater than or equal to about 91 mol %, or greater than or equal to about 94 mol % and less than or equal to about 99 mol % based on 100 mol % of the metal excluding lithium in the lithium transition metal composite oxide. The high-nickel positive electrode active material may achieve high capacity, and may be applicable to high-capacity, high-density rechargeable lithium batteries.

For example, the positive electrode active material may include a lithium nickel-based composite oxide, and may include, for example, a compound represented by Chemical Formula 1 below.

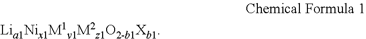

In Chemical Formula 1, 0.9≤a1≤1.8, 0.3≤x1<1, 0≤y1≤0.7, 0≤z1≤0.7, 0.9≤x1+y1+z1≤1.1, and 0≤b1≤0.1, M¹ and M² are different elements and each independently is or includes at least one of Al, B, Ba, Ca, Ce, Co, Cr, Cu, Fe, Mg, Mn, Mo, Nb, Si, Sₙ, Sr, Ti, V, W, Zn, and Zr, and X is or includes at least one of F, P, and S.

In Chemical Formula 1, 0.6≤x1≤1, 0≤y1≤0.4, and 0≤z1≤0.4; or 0.8≤x1≤1, 0≤y1≤0.2, and 0≤z1≤0.2; or 0.9≤x1<1, 0<y1<0.1, and 0≤z1≤0.1.

The positive electrode active material may include, as an example, a lithium nickel-cobalt composite oxide represented by Chemical Formula 2 below.

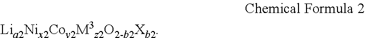

In Chemical Formula 2, 0.9≤a2≤1.8, 0.3≤x2≤1, 0<y2≤0.7, 0≤z2≤0.7, 0.9≤x2+y2+z2≤1.1, and 0≤b2≤0.1, M³ is or includes one or more of Al, B, Ba, Ca, Ce, Cr, Cu, Fe, Mg, Mn, Mo, Nb, Si, Sₙ, Sr, Ti, V, W, Y, Zn, and Zr, and X is or includes one or more of F, P, and S.

In Chemical Formula 2, for example 0.7≤x2<1, 0<y2≤0.3, 0≤z2≤0.3; 0.8≤x2<1, 0<y2≤0.2, 0≤z2<0.2; or 0.9≤x2<1, 0<y2≤0.1, 0≤z2≤0.1.

The positive electrode active material may include, as another example, at least one of a lithium nickel-cobalt-manganese composite oxide, a lithium nickel-cobalt-aluminum composite oxide, or a lithium nickel-cobalt-aluminum-manganese composite oxide represented by Chemical Formula 3 below.

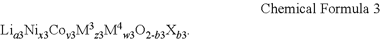

In Chemical Formula 3, 0.9≤a3≤1.8, 0.3≤x3≤0.98, 0.01≤y3≤0.69, 0.01≤z3≤0.69, 0≤w3≤0.69, 0.9≤x3+y3+z3+w3≤1.1, and 0≤b3≤0.1, M⁴ is or includes at least one of Al, Mn, or a combination thereof, M⁵ is or includes one or more of B, Ba, Ca, Ce, Cr, Cu, Fe, Mg, Mo, Nb, Si, Sn, Sr, Ti, V, W, Y, Zn, and Zr, and X is or includes one or more of F, P, and S.

When the electrode active material layer is a positive electrode active material layer, the current collector may include Al, but is not limited thereto.

As another example, the electrode active material may include a negative electrode active material, in which case the electrode may be or include a negative electrode.

A negative electrode for a rechargeable lithium battery includes a current collector, and a negative electrode active material layer on the current collector.

For example, the negative electrode active material may include at least one of a material that reversibly intercalates/deintercalates lithium ions, a lithium metal, a lithium metal alloy, a material capable of doping/dedoping lithium, or a transition metal oxide.

The material that reversibly intercalates/deintercalates lithium ions may include a carbon-based negative electrode active material, for example crystalline carbon, amorphous carbon or a combination thereof. The crystalline carbon may be or include graphite such as non-shaped, sheet-shaped, flake-shaped, sphere-shaped, or fiber-shaped natural graphite or artificial graphite, and the amorphous carbon may be or include at least one of a soft carbon, a hard carbon, a mesophase pitch carbonization product, calcined coke, and the like.

The lithium metal alloy includes an alloy of lithium and a metal such as or including at least one of Na, K, Rb, Cs, Fr, Be, Mg, Ca, Sr, Si, Sb, Pb, In, Zn, Ba, Ra, Ge, Al, and Sn.

The material capable of doping/dedoping lithium may be or include a Si-based negative electrode active material or a Sn-based negative electrode active material. The Si-based negative electrode active material may include at least one of silicon, a silicon-carbon composite, SiOx (0<x≤2), a Si-Q alloy (wherein Q is or includes at least one of an alkali metal, an alkaline-earth metal, a Group 13 element, a Group 14 element (excluding Si), a Group 15 element, a Group 16 element, a transition metal, a rare earth element, and a combination thereof), or a combination thereof. The Sn-based negative electrode active material may include at least one of Sn, SnO₂, a Sn-based alloy, or a combination thereof.

The silicon-carbon composite may be or include a composite of silicon and amorphous carbon. According to some example embodiments, the silicon-carbon composite may be in the form of silicon particles, and amorphous carbon coated on the surface of the silicon particles. For example, the silicon-carbon composite may include a secondary particle (core) in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may be dispersed in an amorphous carbon matrix.

The silicon-carbon composite may further include crystalline carbon. For example, the silicon-carbon composite may include a core including crystalline carbon and silicon particles, and an amorphous carbon coating layer on a surface of the core.

The Si-based negative electrode active material or the Sn-based negative electrode active material may be used in combination with a carbon-based negative electrode active material.

When the electrode active material layer is a negative electrode active material layer, the current collector may be or include at least one of a copper foil, a nickel foil, a stainless-steel foil, a titanium foil, a nickel foam, a copper foam, a polymer substrate coated with a conductive metal, and a combination thereof.

Some example embodiments include a rechargeable lithium battery including the aforementioned electrode, and an electrolyte.

For example, the rechargeable lithium battery may include a positive electrode; a negative electrode, a separator between the positive electrode and the negative electrode, and an electrolyte.

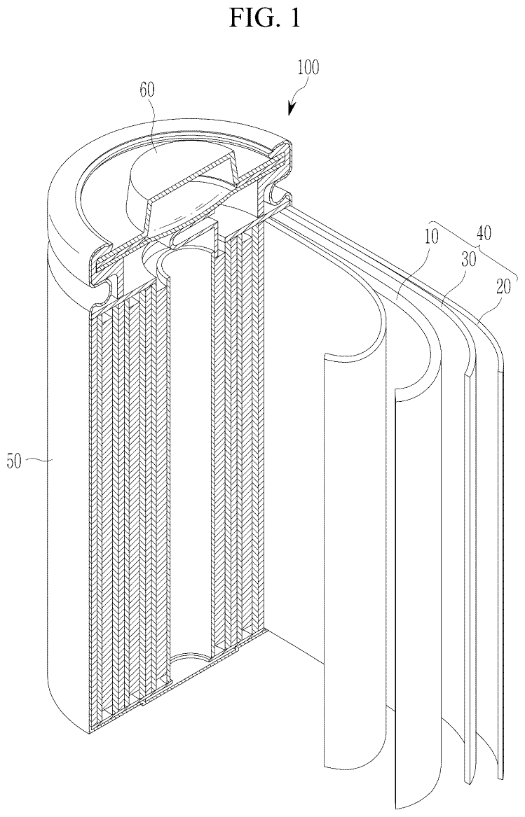

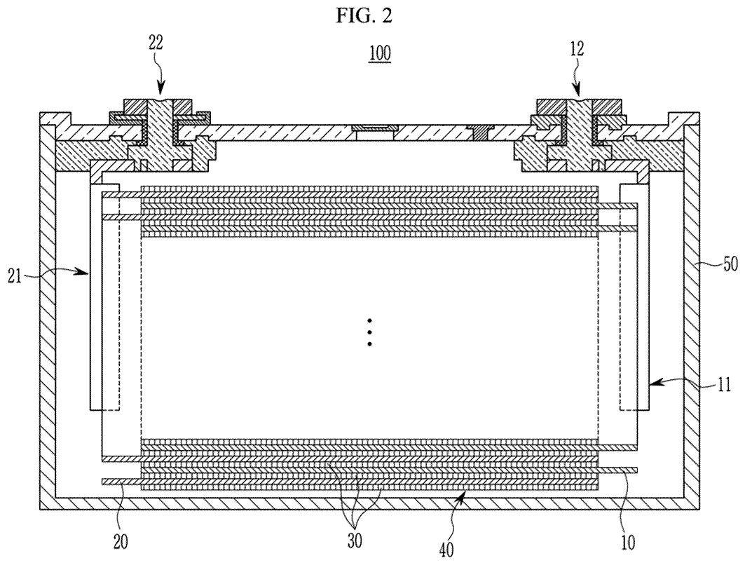

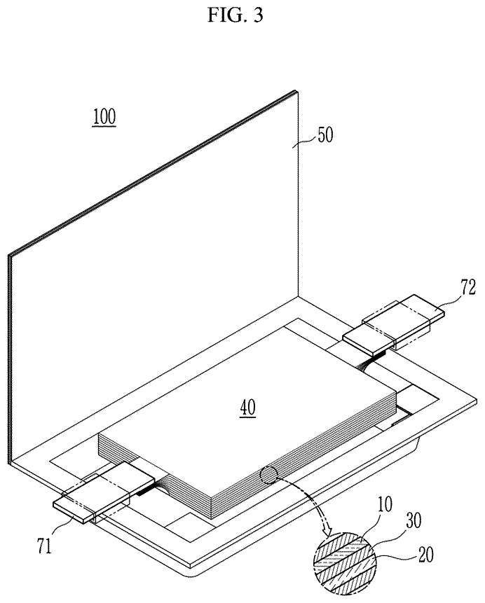

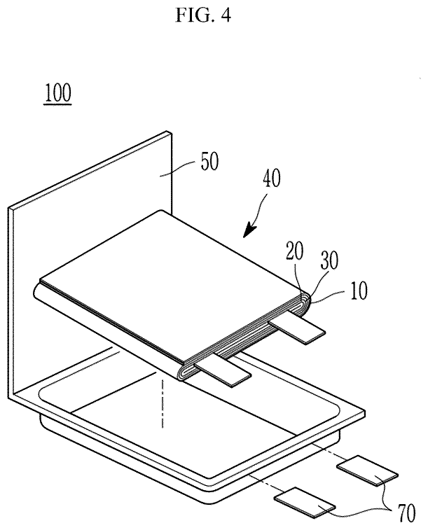

The rechargeable lithium battery may be classified into cylindrical, prismatic, pouch, coin, and the like depending on its shape. FIG. 1 to FIG. 4 are schematic views illustrating rechargeable lithium batteries according to some example embodiments. FIG. 1 shows a cylindrical battery, FIG. 2 shows a prismatic battery, and FIGS. 3 and 4 show pouch-type batteries. Referring to FIGS. 1 to 4, the rechargeable lithium battery 100 includes an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution (not shown). The positive electrode 10, the negative electrode 20, and the separator 30 may be impregnated with an electrolyte solution (not shown). The rechargeable lithium battery 100 may include a sealing member 60 that seals the case 50 as shown in FIG. 1. In FIG. 2, the rechargeable lithium battery 100 may include a positive electrode lead tab 11, a positive electrode terminal 12 connected to the positive electrode lead tab 11, a negative electrode lead tab 21, and a negative electrode terminal 22 connected to the negative electrode lead tab 21. As shown in FIGS. 3 and 4, the rechargeable lithium battery 100 includes an electrode tab 70 illustrated in FIG. 4, or a positive electrode tab 71 and a negative electrode tab 72 illustrated in FIG. 3, the electrode tabs 70/71/72 forming an electric path for inducing the current formed in the electrode assembly 40 to the outside of the battery 100.

The electrolyte solution for a rechargeable lithium battery may include a non-aqueous organic solvent and a lithium salt.

The non-aqueous organic solvent constitutes a medium for transmitting ions taking part in the electrochemical reaction of a battery.

The non-aqueous organic solvent may be or include at least one of a carbonate-based, ester-based, ether-based, ketone-based, or alcohol-based solvent, an aprotic solvent, or a combination thereof.

The carbonate-based solvent may include at least one of dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), butylene carbonate (BC), and the like. The ester-based solvent may include at least one of methyl acetate, ethyl acetate, n-propyl acetate, dimethylacetate, methylpropionate, ethylpropionate, decanolide, mevalonolactone, valerolactone, caprolactone, and the like. The ether-based solvent may include at least one of dibutyl ether, tetraglyme, diglyme, dimethoxyethane, 2-methyltetrahydrofuran, 2,5-dimethyltetrahydrofuran, tetrahydrofuran, and the like. The ketone-based solvent may include cyclohexanone, and the like. The alcohol-based solvent may include at least one of ethanol, isopropyl alcohol, and the like. The aprotic solvent may include at least one of nitriles such as R—CN (wherein R is a C2 to C20 linear, branched, or cyclic hydrocarbon group, a double bond, an aromatic ring, or an ether bond, and the like); amides such as dimethylformamide; dioxolanes such as 1,3-dioxolane, 1,4-dioxolane, and the like; sulfolanes, and the like.

The non-aqueous organic solvent may be used alone, or in a mixture of two or more types of solvents.

When using a carbonate-based solvent, a cyclic carbonate and a chain carbonate may be mixed, and the cyclic carbonate and the chain carbonate may be mixed in a volume ratio in a range of about 1:1 to about 1:9.

The lithium salt dissolved in the organic solvent supplies lithium ions in a battery, enables an operation of a rechargeable lithium battery, and improves transportation of the lithium ions between positive and negative electrodes. For example, the lithium salt may include at least one of LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂), x and y are integers in a range of 1 to 20, lithium trifluoromethane sulfonate, lithium tetrafluoroethanesulfonate, lithium difluorobis(oxalato)phosphate (LiDFOB), and lithium bis(oxalato) borate (LiBOB).

Depending on the type of the rechargeable lithium battery, a separator may be present between the positive electrode and the negative electrode. The separator may include at least one of polyethylene, polypropylene, polyvinylidene fluoride, or a multilayer film of two or more layers thereof, and a mixed multilayer film such as a polyethylene/polypropylene two-layer separator, polyethylene/polypropylene/polyethylene three-layer separator, polypropylene/polyethylene/polypropylene three-layer separator, and the like.

The separator may include a porous substrate and a coating layer including an organic material, an inorganic material, or a combination thereof on one surface, or on both surfaces, of the porous substrate.

The porous substrate may be or include a polymer film formed of or including any one or more of polymer polyolefin such as polyethylene and polypropylene, polyester such as polyethylene terephthalate and polybutylene terephthalate, polyacetal, polyamide, polyimide, polycarbonate, polyether ketone, polyarylether ketone, polyether ketone, polyetherimide, polyamideimide, polybenzimidazole, polyethersulfone, polyphenylene oxide, a cyclic olefin copolymer, polyphenylene sulfide, polyethylene naphthalate, a glass fiber, TEFLON, and polytetrafluoroethylene, or a copolymer or mixture of two or more thereof.

The organic material may include a polyvinylidene fluoride-based polymer or a (meth)acrylic polymer.

The inorganic material may include inorganic particles such as or including at least one of Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and a combination thereof, but is not limited thereto.

The organic material and the inorganic material may be mixed in one coating layer, or a coating layer including an organic material and a coating layer including an inorganic material may be stacked together.

As another example, the rechargeable lithium battery may be or include an all-solid-state rechargeable battery including a positive electrode, a negative electrode, and a solid electrolyte layer between the positive electrode and the negative electrode.

The solid electrolyte layer may include an inorganic solid electrolyte such as a sulfide-based solid electrolyte, an oxide-based solid electrolyte, a halide-based solid electrolyte, and the like, and the inorganic solid electrolyte is as described above.

### Method for Manufacturing Electrode for Rechargeable Lithium Battery

Some example embodiments include a method for manufacturing an electrode for a rechargeable lithium battery, the method including freeze-drying a cellulose nanofiber suspension to prepare cellulose nanofibers, dry mixing the prepared cellulose nanofibers and polytetrafluoroethylene to prepare a mixed binder, dry mixing the mixed binder, an electrode active material, and a conductive material to prepare an electrode mixture, forming the electrode mixture into a sheet to prepare a film, and laminating the film on a current collector to manufacture an electrode.

Each of the above operations is described in detail below.

First, a cellulose nanofiber suspension is prepared. The cellulose nanofiber suspension may be or include a liquid prepared by dispersing cellulose nanofibers in an aqueous solvent.

As an example, the method for manufacturing the electrode may further include wet pulverizing the cellulose nanofiber suspension prior to the freeze-drying step. The wet pulverizing step may be mechanically pulverizing the cellulose nanofibers into nano units, and may be performed through a milling process or an ultrasonic treatment process. The milling process may be performed using a commonly used milling process, and may be performed using, for example, an inline milling device or a disk milling device.

The wet pulverizing step may control the cellulose nanofibers to have an average diameter or an average length within a desired numerical range.

After the wet pulverizing step, the cellulose nanofiber suspension is freeze-dried to prepare the cellulose nanofibers. The freeze-drying process may include dehydrating the cellulose nanofiber suspension to dry the cellulose nanofibers in the suspension into a powder or particle form, while maintaining the fiber form.

A general drying process rather than the freeze-drying step is used to prepare the cellulose nanofibers, which may not be uniformly fiberized but have difficulty having a desired particle diameter and length, resultantly deteriorating mechanical properties of an electrode including the cellulose nanofibers.

For example, the freeze-drying may be performed at a vacuum in a range of about 0.01 mbar to about 1 mbar, for example, about 0.01 mbar to about 0.5 mbar, about 0.01 mbar to about 0.25 mbar, about 0.05 mbar to about 0.25 mbar, or about 0.1 mbar to about 0.25 mbar.

For example, the freeze-drying may be performed at a temperature in a range of about −80° C. to about −40° C., for example, about −60° C. to about −40° C., or about −50° C. to about −40° C.

For example, the freeze-drying may be performed for a duration in a range of about 24 hours to about 72 hours, for example, about 24 hours to about 60 hours, or about 36 hours to about 60 hours.

When the freeze-drying is performed under the above conditions, it is possible to obtain the cellulose nanofibers in the form of powder having a desired diameter or length, while maintaining the desired fiber form. In addition, the cellulose nanofibers prepared through the freeze-drying under the conditions may have embrittlement (brittleness) and may thus be readily pulverized in a subsequent powder-forming step.

For example, the method of manufacturing the electrode may further include a powder-forming step of pulverizing the freeze-dried cellulose nanofibers after the freeze-drying step. The powder-forming step may include pulverizing into powder the cellulose nanofibers entangled with one another after the freeze-drying.

Through the powder-forming step, the cellulose nanofibers may be prepared to have a substantially uniform length and particle diameter, and the prepared cellulose nanofibers may be substantially uniformly dry-mixed with an electrode active material, polytetrafluoroethylene, and a conductive material in a subsequent step of preparing a mixed binder to improve processability. Furthermore, mechanical properties of the electrode including the prepared cellulose nanofibers may be improved.

Subsequently, the method of manufacturing the electrode according to some example embodiments includes preparing the mixed binder by dry-mixing the prepared cellulose nanofibers and polytetrafluoroethylene.

The polytetrafluoroethylene is a hydrophobic material and thus has low impregnation properties of an electrolyte solution, and when the polytetrafluoroethylene is used alone as a binder for a dry electrode, the dry electrode may be challenging to thicken. Accordingly, some example embodiments include mixing the cellulose nanofibers, an amphiphilic material, with the polytetrafluoroethylene to improve the impregnation properties of an electrolyte solution and enhance the electrode thickening.

For example, the prepared cellulose nanofibers and the polytetrafluoroethylene may be mixed in a weight ratio in a range of about 2:8 to about 8:2, for example, about 2.5:7.5 to about 8:2, or about 2.5:7.5 to about 5:5.

The mixed binder dry-mixed within the weight ratios has advantages of constituting a dry binder and improving the impregnation properties of an electrolyte solution, and thus being useful in a thick-film electrode.

Next, the method for manufacturing an electrode according to some example embodiments includes dry mixing the mixed binder, an electrode active material, and a conductive material to prepare an electrode mixture, and forming the electrode mixture into a sheet to manufacture a film.

The dry mixing process means mixing without including a process solvent. The process solvent is, for example, a solvent used for an electrode slurry. The process solvent may be or include, for example, water, NMP, and the like but is not limited thereto, and may include any process solvent used in preparing an electrode slurry.

The dry mixing may be, for example, performed by using a stirrer.

The dry mixing with the stirrer may be performed, for example, at a temperature in a range of about 25° C. to about 85° C., for example, about 25° C. to about 70° C., about 25° C. to about 50° C., or about 25° C. to about 30° C.

The dry mixing with the stirrer may be performed, for example, at a rotation speed in a range of about 500 rpm to about 2000 rpm, for example, about 500 rpm to about 1500 rpm, about 750 rpm to about 1250 rpm, or about 900 rpm to about 1100 rpm.

The dry mixing with the stirrer may be performed, for example, for a duration in a range of about 5 minutes to about 30 minutes, for example, about 5 minutes to about 20 minutes, about 5 minutes to about 15 minutes, about 5 minutes to about 10 minutes, or about 10 minutes to about 15 minutes.

The dry mixing may be, for example, once or twice or more performed.

When the dry-mixing is performed under the above conditions, a sufficiently fibrillated dry binder is produced, improving impregnation properties of an electrolyte solution and adhesive strength of an electrode including the same.

An electrode mixture including the fibrillated dry mixed binder through the dry-mixing may be obtained. For example, the electrode mixture may be subjected to a shear force in a step of processing the electrode mixture into a film with a rolling device, thereby fibrillating the binder.

For example, the stirrer may include a kneader.

For example, the stirrer may include a chamber, one or more rotation shafts disposed inside the chamber; and blades rotatably coupled to the rotating shafts and arranged in a longitudinal direction of the rotating shafts. The blades may be, for example, one or more blades such as at least one of ribbon blades, sigma blades, jet (Z) blades, dispersion blades, and a screw blade. The blades may contribute to preparing a dough-like mixture by effectively mixing an electrode active material, the dry mixed binder, and a conductive material without a solvent.

For example, based on 100 wt % of the electrode mixture, the mixed binder may be included in an amount in a range of about 0.01 wt % to about 10 wt %. When the mixed binder is used in the above amount, desired or improved impregnation properties of an electrolyte solution may be achieved, readily manufacturing a thick-film electrode.

For example, based on 100 wt % of the electrode mixture, the electrode active material may be included in an amount in a range of about 90 wt % to about 99.5 wt %.

For example, based on 100 wt % of the electrode mixture, the conductive material may be included in an amount in a range of about 0.01 wt % to about 5 wt %. When the above ranges for the amounts of the electrode mixture and the conductive material are satisfied, a thick-film electrode with desired or improved lithium ionic conductivity may be manufactured.

In addition, the electrode mixture may further include the aforementioned inorganic solid electrolyte. The inorganic solid electrolyte may be the same as described above.

Subsequently, the step of forming the electrode mixture into a sheet to prepare a film includes molding the electrode mixture into the film.

For example, the step may be performed by feeding the electrode mixture manufactured in the dry method into an extrusion device, and extruding the electrode mixture into a sheet or film form. The extrusion may be performed by using a roll press process, for example, under a pressure in a range of about 4 MPa to about 100 MPa. Within the above range of pressure, the materials in the electrode mixture may be readily combined and substantially uniformly sheeted without damaging the materials. In the step of processing the electrode mixture into the film, the electrode mixture may be subjected to a shear force to fibrillate the binder, thereby forming a strong fiber network and enhancing mechanical stability of an electrode.

Subsequently, the method of manufacturing the electrode according to some example embodiments includes laminating the manufactured film onto a current collector to manufacture an electrode.

For example, the step may be or include laminating the manufactured film onto the current collector such as an aluminum foil or a copper foil, and compressing the laminate by using a roll press process or the like. In addition, optionally, a thermal pressing process may be further performed to reinforce adhesive strength between the dry binder and the current collector.

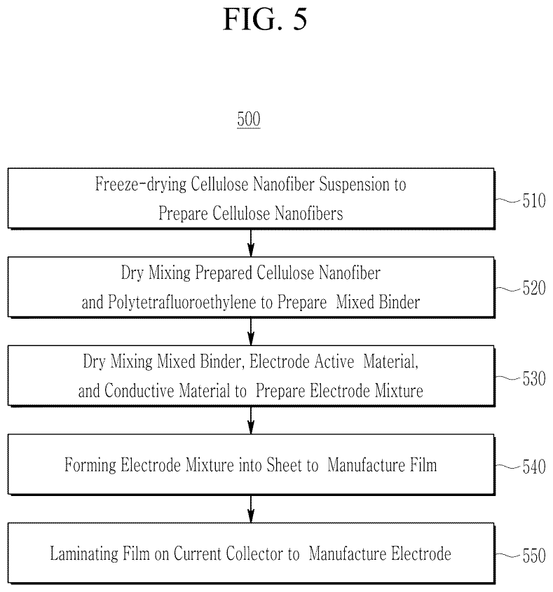

FIG. 5 is a flowchart illustrating a method of manufacturing an electrode for a rechargeable lithium battery, according to some example embodiments. In FIG. 5, the method 500 includes operation 510, which includes freeze-drying cellulose nanofiber suspension to prepare cellulose nanofibers. For example, the freeze-drying is performed at a vacuum in a range of about 0.01 mbar to about 1 mbar, and a temperature in a range of about −80° C. to about −40° C., for about 24 to about 72 hours. Operation 520 includes dry mixing the prepared cellulose nanofiber and polytetrafluoroethylene to prepare a mixed binder. For example, in the preparing of the mixed binder, the prepared cellulose nanofibers and polytetrafluoroethylene are mixed in a weight ratio in a range of about 2:8 to about 8:2. In another example, the mixed binder includes a fibrillated dry mixed binder. Operation 530 includes dry mixing the mixed binder, an electrode active material, and a conductive material to prepare an electrode mixture. Operation 540 includes forming the electrode mixture into a sheet to manufacture a film. For example, in the manufacturing of the film, the mixed binder is included in an amount in a range of about 0.01 wt % to about 10 wt %, the electrode active material is included in an amount in a range of about 90 wt % to about 99.5 wt %, and the conductive material is included in an amount in a range of about 0.01 wt % to about 5 wt %, based on 100 wt % of the electrode mixture. Operation 550 includes laminating the film on a current collector to manufacture an electrode.

In examples, the method 500 further includes a powder forming process of pulverizing the freeze-dried cellulose nanofibers after the freeze-drying cellulose nanofiber suspension to prepare cellulose nanofibers.

Examples and comparative examples of the present disclosure are described below. However, the following examples are only examples of the present disclosure, and the present disclosure is not limited to the following examples.

### EXAMPLES

### Example 1

First, a cellulose nanofiber suspension was prepared and freeze-dried at a vacuum degree of 0.1 mbar and a temperature of −45° C. for 48 hours to prepare cellulose nanofibers (an average diameter: 5 nm, an average length: 10 μm).

The cellulose nanofibers were mixed with polytetrafluoroethylene in a weight ratio of 2.5:7.5 to prepare a mixed binder.

Subsequently, 2 wt % of the mixed binder, 97 wt % of artificial graphite, and 1 wt % of carbon black (SUPER-P) as a conductive material were added to a blade mixer and then, dry-mixed at 1000 rpm for 10 minutes at 25° C. to manufacture an electrode mixture.

The manufactured electrode mixture was put into an extruder and extruded to prepare a self-standing film in the form of sheet.

The self-standing film was laminated onto a copper foil to manufacture a dry negative electrode.

Herein, a negative electrode active material layer disposed on the copper foil current collector had a thickness of 200 μm. In addition, based on 100 wt % of the negative electrode active material layer, 0.5 wt % of the cellulose nanofiber (CNF) 1.5 wt % of the polytetrafluoroethylene (PTFE), 97 wt % of the artificial graphite, and 1 wt % of the conductive material were included.

### Example 2 and Comparative Examples 1-1 to 1-4 and 2-1 to 2-4

Each dry negative electrode was manufactured in the same manner as in Example 1, with a difference that the mixed binder was changed to have a composition and wt % as shown in Table 1.

### Example 3

2 wt % of the mixed binder according to Example 1, 96.5 wt % of LiNi_{0.91}Co_{0.05}Al_{0.04}O₂ as a positive electrode active material, 1 wt % of carbon black (SUPER-P) as a conductive material, and 0.5 wt % of Li₂S—P₂S₅ as a sulfide-based solid electrolyte were added to a blade mixer, and then dry-mixed at 1000 rpm for 10 minutes at 25° C. to manufacture an electrode mixture.

The manufactured electrode mixture was added to an extruder and then, extruded to prepare a self-standing film in the form of sheet.

The self-standing film was laminated onto an aluminum foil to manufacture a dry positive electrode.

Herein, a positive electrode active material layer disposed on the aluminum foil current collector had a thickness of 200 μm. In addition, based on 100 wt % of the positive electrode active material layer, 0.5 wt % of the cellulose nanofiber, 1.5 wt % of the polytetrafluoroethylene, 96.5 wt % of the LiNi_{0.91}Co_{0.05}Al_{0.04}O₂, 1 wt % of the conductive material, and 0.5 wt % of Li₂S—P₂S₅ were included.

### Example 4 and Comparative Examples 3-1 to 3-4 and 4-1 to 4-4

A dry positive electrode was manufactured in the same manner as in Example 3, with a difference that the mixed binder was changed to have a composition and wt % as shown in Table 2.

### Evaluation Examples

### Evaluation Example 1: Adhesive Strength Evaluation

The dry negative electrodes of Examples 1 and 2 and Comparative Examples 1-1 to 2-4 were evaluated with respect to adhesive strength between negative electrode active material layer and copper foil current collector. Specifically, after attaching a 3M Scotch tape onto the surface of each negative electrode active material layer and once rolling the 3M Scotch tape with a metal roller to adhere the 3M Scotch tape thereonto, the tape was detached from the negative electrode active material layer to examine a degree that the negative electrode active material layer was separated from the negative electrode current collector.

If the negative electrode active material layer was separated from the current collector by 5% or less based on an area of the negative electrode active material layer, ‘◯ (excellent)’ was given, if separated by greater than 5% and less than or equal to 20%, ‘Δ (average)’ was given, and if separated by greater than 20%, ‘X (insufficient)’ was given, which are provided in Table 1 below.

In addition, the dry positive electrodes of Examples 3 and 4 and Comparative Examples 3-1 to 4-4 were evaluated with respect to adhesive strength between positive electrode active material layer and aluminum foil current collector. Specifically, after attaching a 3M Scotch tape onto the surface of each positive electrode active material layer and once rolling the 3M Scotch tape with a metal roller to adhere the 3M Scotch tape thereonto, the tape was detached from the positive electrode active material layer to examine a degree that the positive electrode active material layer was separated from the positive electrode current collector.

If the positive electrode active material layer was separated from the current collector by 5% or less based on an area of the positive electrode active material layer, ‘◯ (excellent)’ was given, if separated by greater than 5% and less than or equal to 20%, ‘Δ (average)’ was given, and if separated by greater than 20%, ‘X (insufficient)’ was given, which are provided in Table 1 below.

### Evaluation Example 2: Evaluation of Impregnation Properties of Electrolyte Solution

The negative and positive electrodes of the examples and the comparative examples were measured with respect to impregnation properties of an electrolyte solution by cutting each of the electrodes to prepare an electrode sample with each width and length of 20 mm, and then dropping 20 μl of the electrolyte solution onto the surface of the sample to measure time until the electrolyte solution was completely penetrated thereinto and thus check an impregnation/immersion degree of the electrolyte solution.

If the impregnation/immersion time was less than or equal to 25 seconds, ‘◯ (excellent)’ was given, if greater than 25 seconds to less than or equal to 50 seconds, ‘Δ (average)’ was given, and if greater than 50 seconds, ‘X (insufficient)’ was given, which are shown in Tables 1 and 2 below.

In Tables 1 and 2, PVDF is a polyvinylidene fluoride binder, CMC is a carboxymethyl cellulose binder, and SBR is a styrene butadiene rubber binder.

TABLE 1

| | | | | | | | Impregnation |
|---|---|---|---|---|---|---|---|
| | | | | | | | properties of |
| | Binder (wt %) | | | | | Adhesive | electrolyte |
| | CNF | PTFE | PVDF | CMC | SBR | strength | solution |
| Example 1 | 0.5 | 1.5 | 0 | 0 | 0 | ◯ | ◯ |
| Example 2 | 1 | 1 | 0 | 0 | 0 | ◯ | ◯ |
| Comparative | 2 | 0 | 0 | 0 | 0 | Δ | ◯ |
| Example 1-1 | | | | | | | |
| Comparative | 1 | 0 | 1 | 0 | 0 | X | Δ |
| Example 1-2 | | | | | | | |
| Comparative | 1 | 0 | 0 | 1 | 0 | X | Δ |
| Example 1-3 | | | | | | | |
| Comparative | 1 | 0 | 0 | 0 | 1 | X | Δ |
| Example 1-4 | | | | | | | |
| Comparative | 0 | 2 | 0 | 0 | 0 | ◯ | X |
| Example 2-1 | | | | | | | |
| Comparative | 0 | 0 | 2 | 0 | 0 | X | X |
| Example 2-2 | | | | | | | |
| Comparative | 0 | 0 | 0 | 2 | 0 | X | X |
| Example 2-3 | | | | | | | |
| Comparative | 0 | 0 | 0 | 0 | 2 | X | X |
| Example 2-4 | | | | | | | |

Referring to Table 1, the negative electrodes manufactured by including CNF and PTFE (Examples 1 and 2) in a dry method were confirmed to exhibit desired or improved adhesive strength and impregnation properties of an electrolyte solution.

Comparative Example 1-1 including CNF but not including PTFE was confirmed to exhibit inferior adhesive strength to Examples 1 and 2.

In Comparative Examples 1-2 to 1-4 using PVDF, CMC, and SBR which were difficult to use as a dry binder (must be dissolved in a solvent and were difficult to use in a dry process) in a combination with CNF, it was difficult to manufacture a dry electrode itself, resulting in insufficient adhesive strength of the electrodes. Comparative Examples 1-2 to 1-4 including CNF exhibited average impregnation properties of an electrolyte solution, which was still inferior to Examples 1 and 2.

In addition, the electrode of Comparative Example 2-1, which included PTFE, a dry binder, alone, exhibited desired or improved adhesive strength but which included no combination with CNF, exhibited insufficient impregnation properties of an electrolyte solution.

Furthermore, the negative electrodes of Comparative Examples 2-2 to 2-4 including PVDF, CMC, and SBR alone, which were difficult to use as a dry binder were difficult to manufacture as a dry electrode, were confirmed to exhibit insufficient adhesive strength and impregnation properties of an electrolyte solution.

TABLE 2

| | | | | | | | Impregnation |
|---|---|---|---|---|---|---|---|
| | | | | | | | properties of |
| | Binder (wt %) | | | | | Adhesive | electrolyte |
| | CNF | PTFE | PVDF | CMC | SBR | strength | solution |
| Example 3 | 0.5 | 1.5 | 0 | 0 | 0 | ◯ | ◯ |
| Example 4 | 1 | 1 | 0 | 0 | 0 | ◯ | ◯ |
| Comparative | 2 | 0 | 0 | 0 | 0 | Δ | ◯ |
| Example 3-1 | | | | | | | |
| Comparative | 1 | 0 | 1 | 0 | 0 | X | Δ |
| Example 3-2 | | | | | | | |
| Comparative | 1 | 0 | 0 | 1 | 0 | X | Δ |
| Example 3-3 | | | | | | | |
| Comparative | 1 | 0 | 0 | 0 | 1 | X | Δ |
| Example 3-4 | | | | | | | |
| Comparative | 0 | 2 | 0 | 0 | 0 | ◯ | X |
| Example 4-1 | | | | | | | |
| Comparative | 0 | 0 | 2 | 0 | 0 | X | X |
| Example 4-2 | | | | | | | |
| Comparative | 0 | 0 | 0 | 2 | 0 | X | X |
| Example 4-3 | | | | | | | |
| Comparative | 0 | 0 | 0 | 0 | 2 | X | X |
| Example 4-4 | | | | | | | |

Referring to Table 2, the positive electrodes manufactured by including both CNF and PTFE in a dry method (Examples 3 and 4) all exhibited desired or improved adhesive strength and impregnation properties of an electrolyte solution.

Comparative Example 3-1 including CNF but not PTFE was confirmed to exhibit inferior adhesive strength to Examples 3 and 4.

In Comparative Examples 3-2 to 3-4 using PVDF, CMC, and SBR which were difficult to use as a dry binder (must be dissolved in a solvent and were difficult to use in a dry process) in a combination with CNF, it was challenging to manufacture a dry electrode itself, resulting in insufficient adhesive strength of the electrodes. Comparative Examples 3-2 to 3-4 including CNF exhibited average impregnation properties of an electrolyte solution, which was inferior to Examples 3 and 4.

In addition, Comparative Example 4-1 including PTFE alone, a dry binder, exhibited desired or improved adhesive strength of the electrode but had no combination with CNF, and thus exhibited insufficient impregnation properties of an electrolyte solution.

In addition, the negative electrodes of Comparative Examples 4-2 to 4-4 manufactured by including PVDF, CMC, and SBR alone, which were difficult to use as a dry binder, were difficult to manufacture as a dry electrode and thus confirmed to exhibit insufficient adhesive strength and impregnation properties of an electrolyte solution.

While this disclosure has been described in connection with what is presently considered to be practical example embodiments, it is to be understood that the disclosure is not limited to the disclosed embodiments. On the contrary, the disclosure is intended to cover various modifications and equivalent arrangements included within the spirit and scope of the appended claims.

Description of Symbols:

| | |
|---|---|
| 100: rechargeable lithium battery | 10: positive electrode |
| 11: positive electrode lead tab | 12: positive electrode terminal |
| 20: negative electrode | 21: negative electrode lead tab |
| 22: negative electrode terminal | 30: separator |
| 40: electrode assembly | 50: case |
| 60: sealing member | 70: electrode tab |
| 71: positive electrode tab | 72: negative electrode tab |

What is claimed is:

1. An electrode for a rechargeable lithium battery, the electrode comprising:
a current collector; and
an electrode active material layer disposed on the current collector and comprising an electrode active material, cellulose nanofibers, and polytetrafluoroethylene.

2. The electrode as claimed in claim 1, wherein:
an average diameter of the cellulose nanofibers is in a range of about 0.1 nm to about 200 nm, and
an average length of the cellulose nanofibers is in a range of about 1 μm to about 20 μm.

3. The electrode as claimed in claim 1, wherein the cellulose nanofiber is included in an amount in a range of about 0.01 wt % to about 5 wt % based on 100 wt % of the electrode active material layer.

4. The electrode as claimed in claim 1, wherein the cellulose nanofiber is prepared by freeze-drying.

5. The electrode as claimed in claim 1, wherein the polytetrafluoroethylene is included in an amount in a range of about 0.01 wt % to about 5 wt % based on 100 wt % of the electrode active material layer.

6. The electrode as claimed in claim 1, wherein a weight ratio of the cellulose nanofibers to the polytetrafluoroethylene is in a range of about 2:8 to about 8:2.

7. The electrode as claimed in claim 1, wherein:
the electrode active material layer further comprises a conductive material, and
the conductive material comprises a carbon-based conductive material.

8. The electrode as claimed in claim 1, wherein:
the electrode active material layer further comprises an inorganic solid electrolyte, and
the inorganic solid electrolyte comprises a sulfide-based solid electrolyte.

9. The electrode as claimed in claim 1, wherein the electrode is manufactured by a dry process.

10. The electrode as claimed in claim 1, wherein:
the electrode active material layer further comprises a solvent comprising one of an organic solvent and an aqueous solvent, and
the solvent is included in an amount less than about 0.01 wt % based on 100 wt % of the electrode active material layer.

11. The electrode as claimed in claim 1, wherein a thickness of the electrode active material layer is in a range of about 150 μm to about 500 μm.

12. The electrode as claimed in claim 1, wherein:
the electrode active material comprises a positive electrode active material, and
the positive electrode active material comprises a lithium nickel-based composite oxide represented by Chemical Formula 1: 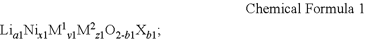
wherein, in Chemical Formula 1, 0.9≤a1≤1.8, 0.3≤x1≤1, 0≤y1≤0.7, 0≤z1≤0.7, 0.9≤x1+y1+z1≤1.1, and 0≤b1≤0.1,
M¹ and M² are different elements, and each independently comprises at least one of Al, B, Ba, Ca, Ce, Co, Cr, Cu, Fe, Mg, Mn, Mo, Nb, Si, Sₙ, Sr, Ti, V, W, Zn, and Zr, and
X comprises at least one of F, P, and S.

13. The electrode as claimed in claim 1, wherein:
the electrode active material comprises a negative electrode active material; and
the negative electrode active material comprises at least one of a carbon-based negative electrode active material, a Si-based negative electrode active material, a Sₙ-based negative electrode active material, and a combination thereof.

14. A method for manufacturing an electrode for a rechargeable lithium battery, the method comprising:
freeze-drying cellulose nanofiber suspension to prepare cellulose nanofibers;
dry mixing the prepared cellulose nanofiber and polytetrafluoroethylene to prepare a mixed binder;
dry mixing the mixed binder, an electrode active material, and a conductive material to prepare an electrode mixture;
forming the electrode mixture into a sheet to manufacture a film; and
laminating the film on a current collector to manufacture an electrode.

15. The method as claimed in claim 14, wherein the freeze-drying is performed at a vacuum in a range of about 0.01 mbar to about 1 mbar, and at a temperature in a range of about −80° C. to about −40° C. for about 24 to about 72 hours.

16. The method as claimed in claim 14, wherein the method further comprises:
a powder forming process of pulverizing the freeze-dried cellulose nanofibers after the freeze-drying cellulose nanofiber suspension to prepare cellulose nanofibers.

17. The method as claimed in claim 14, wherein in the preparing of the mixed binder:
the prepared cellulose nanofibers and polytetrafluoroethylene are mixed in a weight ratio in a range of about 2:8 to about 8:2.

18. The method as claimed in claim 14, wherein the mixed binder comprises a fibrillated dry mixed binder.

19. The method as claimed in claim 14, wherein in the manufacturing of the film:
the mixed binder is included in an amount in a range of about 0.01 wt % to about 10 wt %;
the electrode active material is included in an amount in a range of about 90 wt % to about 99.5 wt %; and
the conductive material is included in an amount in a range of about 0.01 wt % to about 5 wt %, based on 100 wt % of the electrode mixture.

20. A rechargeable lithium battery comprising:
an electrode as claimed in claim 1; and
an electrolyte.
